(19) United States
(12) Patent Application Publication
(10) Pub. No.: US 2023/0016428 A1
(43) Pub. Date: Jan. 19, 2023

(54) VIEWED POST INDICATIONS ACROSS MULTIPLE POST INSTANCES

(71) Applicant: Avaya Management L.P., Durham, NC (US)

(72) Inventors: Pushkar Yashavant Deole, Pune (IN); Sandesh Chopdekar, Pune (IN); Navin Daga, Silapathar (IN)

(21) Appl. No.: 17/374,043

(22) Filed: Jul. 13, 2021

(51) Int. Cl. H04L 12/58

(52) U.S. Cl. CPC H04L 51/16

(57) ABSTRACT

The technology disclosed herein enables an indication of a post having been viewed to be presented across multiple instances of the post. In a particular embodiment, a method provides, in response to determining that a user has viewed a first instance of a post to an electronic communication channel, associating the post with a viewed-post status in a post-tracking repository. The method further provides identifying a second instance of the post and indicating to the user that the second instance has been viewed based on the post being associated with the viewed-post status.

### TECHNICAL BACKGROUND

Posting platforms, such as social networking websites/applications and message boards, are an increasingly popular means for people to communicate. Given the numerous posting platforms, and even channels (e.g., user groups) within a particular platform, that are available to users, instances of a single post may be spread across multiple platforms and/or channels. For example, a user may view a post to one of their groups and then share that post to another group. At least two instances of the post would then exist. Even if another user of both groups viewed the instance of the post in one group, that status of that post would still indicate the post has not been viewed in the other group. Thus, that user may waste time and bandwidth to download and view the other instance of the post even though the user has already viewed the post in another group.

### SUMMARY

The technology disclosed herein enables an indication of a post having been viewed to be presented across multiple instances of the post. In a particular embodiment, a method provides, in response to determining that a user has viewed a first instance of a post to an electronic communication channel, associating the post with a viewed-post status in a post-tracking repository. The method further provides identifying a second instance of the post and indicating to the user that the second instance has been viewed based on the post being associated with the viewed-post status.

In some embodiments, indicating to the user that the second instance has been viewed includes displaying the second instance with a visual indicator thereon that is representative of the post having already been viewed. In those embodiments, the visual indicator may be a first color that is different than a color that is representative of an unviewed post.

In some embodiments, indicating to the user that the second instance has been viewed includes determining that a posting group includes new posts, including the second instance, since last opened by the user and displaying a group indicator for the posting group with a visual indicator that at least one of the new posts has already been viewed. In those embodiments, the visual indicator may indicate a proportion of the new posts that have already been viewed. In some embodiments, the proportion may be represented by an amount in which a shape of the visual indicator is filled with a first color.

In some embodiments, associating the post with the viewed-post status includes determining a unique identifier for the post, including the unique identifier in the post-tracking repository, and including the unique identifier in metadata of the post. In those embodiments identifying the second instance includes finding the unique identifier in metadata of the second instance.

In some embodiments, associating the post with the viewed-post status includes generating a checksum for the post and including the checksum in the post-tracking repository. In those embodiments, identifying the second instance includes generating a second checksum for the second instance and determining that the second checksum matches the checksum in the post-tracking repository.

In some embodiments, the second instance is identified from a second electronic communication channel.

In some embodiments, in response to determining that a threshold amount of time has elapsed since associating the post with the viewed-post status, the method includes disassociating the post from the viewed-post status.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to, in response to determining that a user has viewed a first instance of a post to an electronic communication channel, associate the post with a viewed-post status in a post-tracking repository. The program instructions further direct the processing system to identify a second instance of the post and indicate to the user that the second instance has been viewed based on the post being associated with the viewed-post status.

### BRIEF DESCRIPTION OF THE DRAWINGS

FIG. 1 illustrates an implementation for indicating that a post has been viewed across multiple instances of the post.

FIG. 2 illustrates an operation to indicate that a post has been viewed across multiple instances of the post.

FIG. 3 illustrates an operational scenario for indicating that a post has been viewed across multiple instances of the post.

FIG. 4 illustrates an operational scenario for indicating that a post has been viewed across multiple instances of the post.

FIG. 5 illustrates an operational scenario for indicating that a post has been viewed across multiple instances of the post.

FIG. 6 illustrates an operational scenario for indicating that a post has been viewed across multiple instances of the post.

FIG. 7 illustrates an implementation for indicating that a post has been viewed across multiple instances of the post.

FIG. 8 illustrates an implementation for indicating that a post has been viewed across multiple instances of the post.

FIG. 9 illustrates an implementation for indicating that a post has been viewed across multiple instances of the post.

FIG. 10 illustrates a computing architecture for indicating that a post has been viewed across multiple instances of the post.

### DETAILED DESCRIPTION

The examples provided herein store the viewed status of a post in a repository. The repository may then be referenced to determine whether a post has already been viewed. When a new post is posted to a communication channel, the repository is referenced to determine whether an instance of the post has already been viewed by the user either in the same channel or elsewhere (e.g., in another communication channel either on the same posting platform or a different posting platform). If the post has not been viewed, as indicated by the repository, then the post is indicated to have not been viewed. However, if the repository indicates that an instance of the post has been viewed elsewhere, then an indication is provided to the user that the post has already been viewed. As such, a user is informed that an instance of a post has already been viewed in a communication channel even if the post was not viewed in that particular channel.

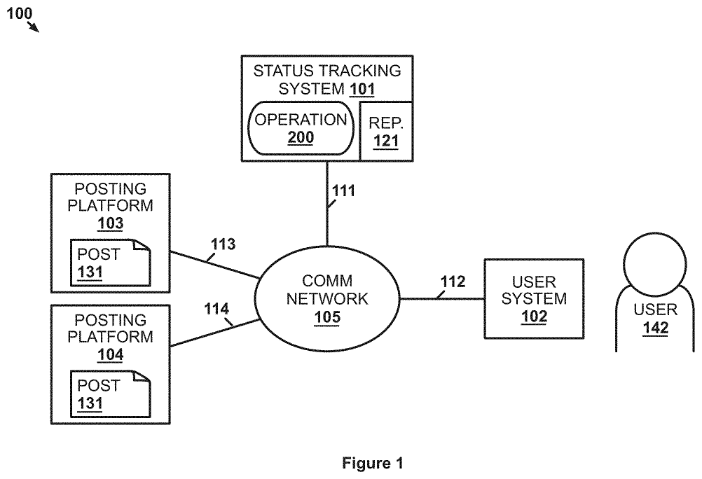

FIG. 1 illustrates implementation 100 for indicating that a post has been viewed across multiple instances of the post. Implementation 100 includes status tracking system 101, user system 102, posting platform 103, posting platform 104, and communication network 105. Status tracking system 101 and communication network 105 communicate over communication link 111. User system 102 and communication network 105 communicate over communication link 112. Posting platform 103 and communication network 105 communicate over communication link 113. Posting platform 104 and communication network 105 communicate over communication link 114. Communication links 111-114 are shown as direct links but may include intervening systems, networks, and/or devices. Communication network includes one or more local area networks and/or wide area computing networks, such as the Internet, over which systems 103-104 communicate.

In operation, posting platform 103 and posting platform 104 are each a computing system (e.g., server), or collection of computing systems, that hosts a communication platform that enables users to post content for consumption by other users. The content may be text-based messages, photographs, video, audio, web addresses (e.g., a link to an article), or any other type of content supported by posting platform 103 and/or posting platform 104—including combinations thereof. Posting platform 103/104 may be available to the public (e.g., may be a public social network) and/or may be a private communication platform available to select individuals (e.g., employees of an enterprise). In some cases, posting platform 103/104 may be a remote (e.g., in a cloud server location) system while, in other cases, posting platforms 103/104 may be an on-premises system (e.g., physically located in a building belonging to an enterprise using conversation platform system 102).

User 142 operates user system 102 to access posts stored on posting platform 103 and posting platform 104. User system 102 may be a telephone, tablet computer, laptop computer, desktop computer, conference room system, or some other type of computing device. User system 102 may execute an application associated with posting platform 103 and/or posting platform 104 to access posts stored thereon or may access through a web browser directed to a website associated with posting platform 103 and/or posting platform 104. For instance, posting platform 103 may have an application for interacting therewith that is executed by user system 102 and/or may host a website for interacting therewith. Posting platform 104 may similarly provide different application/website to user system 102 for interacting therewith.

Status tracking system 101 is a computing system that tracks whether user 142 has read posts on posting platform 103 and/or posting platform 104 by storing the viewed status of posts in status repository 121, as detailed below. Status repository 121 may include one or more volatile and/or non-volatile memory, such as random access memory, flash memory, hard disk drives, solid state drives, tape drives/cartridges, optical drives/media, and/or some other computer-accessible data storage device. In no examples would status repository 121 be considered a mere propagated signal. Status repository 121 may be internal to status tracking system 101, may be connected to status tracking system 101 over communication network 105 (e.g., either a local network attached storage or cloud storage system), or may be a storage system accessible to status tracking system 101 in some other manner. While shown separately from user system 102, in some examples, the functionality of status tracking system 101 may be incorporated into user system 102 or one of posting platforms 103 and 104.

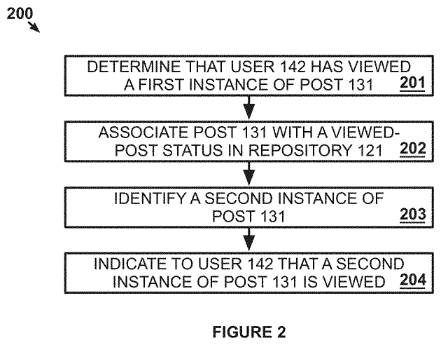

FIG. 2 illustrates operation 200 to indicate that a post has been viewed across multiple instances of the post. Operation 200 is performed by status tracking system 101. In this example, post 131 is content that was submitted (e.g., originally created in or shared to) posting platform 103. Typically, post 131 may be submitted by a user but automated posting mechanisms may also be used (e.g., a bot may be configured to crawl websites for articles on a topic and post a link to a found article). Post 131 in posting platform 103 is an instance of post 131 in a channel that is accessible for viewing by user 142. For example, post 131 may be posted in a communication channel (e.g., message thread, posting timeline, etc.) for a group that includes user 142 and a selection of their friends. When user 142 views the instance of post 131 in posting platform 103, status tracking system 101 determines that user 142 has viewed post 131 (201). Status tracking system 101 may communicate with user system 102 or with posting platform 103 or vice versa (e.g., using application programming interfaces (APIs) of the respective platforms/systems and/or user 142 may give status tracking system 101 permission to access their communication channel(s) on posting platform 103) to determine that user 142 has viewed post 131. For example, when post 131 is retrieved by user system 102 from posting platform 103 and presented to user 142, then posting platform 103 may mark post 131 as having been viewed. Status tracking system 101 may then recognize through its own connection with posting platform 103 that post 131 has been marked as viewed. Alternatively, user system 102 may notify status tracking system 101 that post 131 has been viewed. For example, a browser plugin, or other type of software application client of status tracking system 101, executing on user system 102 may send a message to status tracking system 101 when user 142 views post 131 or may notify status tracking system 101 in some other manner (e.g., using APIs of status tracking system 101). In some examples, the application may use its own independent criteria for determining that a post has been viewed (e.g., the post has been presented for a threshold amount of time) or may rely on post 131 being marked as viewed in posting platform 103.

In response to status tracking system 101 determining that the instance of post 131 has been viewed, status tracking system 101 associates post 131 with a viewed-post status in status repository 121 (202). The viewed-post status associated with post 131 indicates that at least one instance of post 131 has been viewed by user 142. Status tracking system 101 may associate the viewed-post status with post 131 by including an identifier unique to post 131 in status repository 121, by including a checksum derived from post 131 (either by status tracking system 101 or user system 102) in status repository 121, or by identifying post 131 in status repository 121 in some other manner. The unique identifier for post 131 may be assigned to post 131 by posting platform 103 or by a posting platform on which post 131 originated (if not posting platform 103). The unique identifier assigned by a posting platform may, therefore, be included in metadata of post 131, or otherwise attached to post 131, such that anytime post 131 is shared, or otherwise copied, to create a new instance of post 131, the identifier is propagated to the new instance. In some cases, the mere existence of an identifier for post 131 in status repository 121 indicates that post 131 has the viewed-post status. In other cases, status tracking system 101 may explicitly include an indicator of the viewed-post status, which may be useful if status tracking system 101 also tracks other potential statuses that may be used for other purposes (e.g., an intermediate status may exist for a post that has been downloaded to user system 102 but has not yet been viewed). For instance, even if a post has yet to be viewed by user 142, status tracking system 101 may include an identifier for the post in status repository 121 and then update a status for the identifier to the viewed-post status when/if the post is eventually viewed.

After post 131 has been associated with the viewed-post status in status repository 121, status tracking system 101 identifies another instance of post 131 (203). The other instance of post 131 may be in a channel accessible by user 142 on posting platform 103 other than the channel in which the above-discussed instance of post 131 is posted or may be in a channel on posting platform 104 that is accessible by user 142. For example, user 142 may belong to two groups hosted by posting platform 103. The first instance of post 131, discussed above, may be posted to one of the groups and the second instance may be posted to the other. In another example, posting platform 103 and posting platform 104 may be different social networks used by user 142 and instances of post 131 may be shared to communication channels in each network that are accessible by user 142. Like the first instance above, status tracking system 101 may identify the second instance from communicating with posting platform 103 (or posting platform 104) or by communicating with user system 102. To identify the second instance, status tracking system 101 may extract the unique identifiers for posts accessible by user 142 (e.g., all posts, posts that posting platform 103/104 indicate have not been viewed, or posts posted within a threshold amount of time) and determine whether any of the unique identifiers match the unique identifier for post 131 stored in status repository 121. Likewise, if a checksum is used instead, status tracking system 101 may derive the respective checksums for the posts and determine whether any of the checksums match the checksum stored in status repository 121 for post 131. Status tracking system 101 may wait until user 142 is about to view posts in a particular platform (e.g., wait until user 142 logs into posting platform 103/104) to monitor for a second instance, may periodically check for new posts in channels accessible by user 142, may check for a second instance upon the first instance being viewed, or may identify the second instance at some other time. In some examples, the second instance of post 131 may be posted before the first instance even though user 142 views the first instance before the second instance. In those examples, status tracking system 101 may have already identified the second instance of post 131 prior to post 131 being associated with the viewed-post status in status repository 121. In some embodiments, actions performed by status tracking system 101 may instead be performed by user system 102 (e.g., at the direction of a client application) in communication with status tracking system 101 (e.g., using APIs of status tracking system 101 to access/manage status repository 121).

Since status repository 121 indicates that post 131 has the viewed-post status, status tracking system 101 indicates to user 142 that the second instance has been viewed (204). In some examples, status tracking system 101 may communicate with posting platform 103/104 directly (e.g., using APIs), to direct the posting platform to mark the second instance as viewed (even if user 142 has yet to view the second instance). Similarly, status tracking system 101 may direct user system 102 (e.g., via a client application executing thereon) to mark the second instance as viewed. Marking the second instance as viewed causes the platform hosting the second instance to not present the second instance as new to user 142. In other examples, status tracking system 101 may not change the viewed status of the second instance on posting platform 103/104. Rather, a client application on user system 102 (e.g., the client application, e.g., browser plugin, that sends post information to status tracking system 101) may present viewed-post status information to user 142. For instance, if the second instance is in a channel of posting platform 104, the client application may overlay information on the displayed interface of posting platform 104 at user system 102 or may otherwise visually associate the viewed-post status information with the second instance. For example, the information may be a graphical notifier displayed on, or nearby, the second instance itself (e.g., may be a colored graphical indicator indicating that the second instance has already been viewed) or the display of the second instance may be modified in a way that indicates to user 142 that user 142 has already viewed post 131 (e.g., the display of the second instance may be greyed out relative to other posts that have not already been viewed). Similarly, even before the channel of posts containing the second instance is opened, an indicator may be presented nearby an identifier for the channel. For example, status tracking system 101 may direct user system 102 to display an indication of how many of the new posts in a group are posts that user 142 has not already viewed and the second instance of post 131 would not be included in that count. The indicator may be displayed in addition to a new post count provided by the posting platform or may supplant the platform's new post count (e.g., may be overlaid on top of that count so as to obscure it from view). Other manners of indicating to user 142 that the second instance has already been viewed may also, or instead, be used (e.g., an audible and/or tactile notification or a different type of visual indicator than those described above).

In some examples, status tracking system 101 may keep post 131 associated with the viewed post status for a threshold amount of time before disassociating post 131 from the viewed post status in status repository 121. Once post 131 is no longer associated with the viewed post status, post 131 will not be considered to have already been viewed. Instances of post 131 known to status tracking system 101, therefore, will not (or will no longer) be indicated to user 142 as being viewed. Should one of those instances be viewed by user 142, then status tracking system 101 may again associate post 131 with the viewed post status in status repository 121. By placing a time limit on how long post 131 is considered viewed, user 142 may revisit post 131 thinking it is unviewed, which may be beneficial for user 142 to refresh their memory regarding post 131's contents. The time limit threshold may be user defined, may be a default value, or may be defined in some other manner.

Advantageously, by indicating to user 142 that the second instance of post 131 has already been viewed (i.e., because the first instance of post 131 has been viewed), user 142 does not have to waste time (or bandwidth needed to download content, especially audio/video, in some cases where viewed posts are not retrieved) attempting to view post 131 again. While operation 200 is only described with respect to a single post 131, and two instances thereof, operation 200 may be performed on any number of posts maintained by posting platform 103 and/or posting platform 104 (or any other posting platform supported by status tracking system 101). Thus, status tracking system 101 will provide an indication to user 142 for all instances of posts that status tracking system 101 has determined to have already been viewed by user 142. For example, post 131 may be unread across four instances and, upon status tracking system 101 determining that one of those instances has been viewed, the other three instances are indicated by status tracking system 101 to have also been viewed. In some examples, status tracking system 101 may also track the viewed status of posts for more than just user 142. The viewed statuses for other users may be stored in status repository 121, and associated with the corresponding users therein (e.g., by associating the statuses with user identifiers of the respective users), or status tracking system 101 may use other repositories.

As noted above, the functionality of status tracking system 101 may be incorporated into user system 102. Tracking viewed-post status of posts in status repository 121 may, therefore, be handled all locally to user system 102. Although, by using a separate system accessible over communication network 105, like status tracking system 101, the viewed-post status may be accessible to user 142 even when user 142 is operating a device other than user system 102.

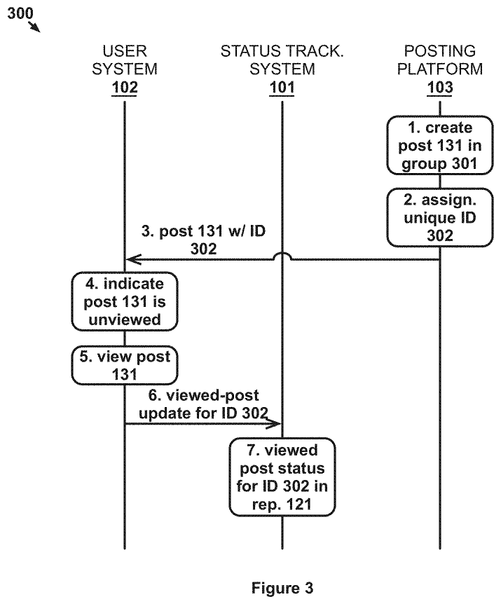

FIG. 3 illustrates operational scenario 300 for indicating that a post has been viewed across multiple instances of the post. At step 1 of operational scenario 300, post 131 is created at posting platform 103 in group 301. In this example, post 131 is created by a user, other than user 142, that is able (e.g., has permissions) to post content to group 301. Group 301 is a communication channel (e.g., message board, timeline of posts, etc.) to which at least the user that created post 131 and user 142 have access. When post 131 is created, posting platform 103 assigns unique identifier 302 to post 131 at step 2. Unique identifier 302 is an identifier that is unique among all other unique identifiers for posts maintained by posting platform 103 such that post 131 can be identified relative to other posts in posting platform 103 by unique identifier 302 alone. Posting platform 103 may include unique identifier 302 in metadata for post 131, in a tag for post 131, or may attached unique identifier 302 to post 131 in some other manner.

After post 131 is created, post 131 (with unique identifier 302 attached) is sent from posting platform 103 at step 3 to user system 102. In other examples, less than the entire post may be sent to user system 102 along with unique identifier 302 (e.g., a title, or clip from the post's content, may be sent and the whole post may then be sent when user 142 selects the title or otherwise opens post 131). Posting platform 103 may transmit post 131 in response to user 142 directing an application executing on user system 102 to open group 301 to display the posts contained therein, which includes post 131. Once group 301 is opened, user 142 may scroll through the posts contained therein. Initially, user system 102 indicates to user 142 that post 131 is an unviewed post at step 4. Post 131 may be indicated as being unviewed based on status tracking system 101 indicating that no instance of post 131 has been viewed by user 142 yet in a manner similar to that described in operational scenario 400, based on user system 102 assuming that post 131 has not been viewed based on the creation time of post 131 (e.g., post 131 may have just been created and is, therefore, unlikely to have been shared/viewed elsewhere), or based on some other reasoning. Regardless, at step 5, user 142 views post 131. Post 131 may be considered to be viewed when user 142 opens post 131 (e.g., selects post 131 from a listing of posts), when post 131 has been displayed for longer than a threshold amount of time (e.g., 3 seconds), when user 142 scrolls to post 131 in situations where posts do not need to be explicitly opened, when user 142 explicitly indicates that post 131 has been viewed (e.g., selects a “mark as viewed” option), or when post 131 satisfies some other criteria for being viewed (e.g., opening downloaded content from post 131).

User system 102 notifies status tracking system 101 at step 6 that post 131 has been viewed by sending a message instructing status tracking system 101 to update unique identifier 302 in status repository 121 with the viewed-post status. In response to that message, at step 7, status tracking system 101 stores unique identifier 302 in status repository 121 (if not stored already) and associates unique identifier 302 therein with the viewed-post status. Since unique identifier 302 identifies post 131, there is no need for status tracking system 101 to store post 131 itself in order to identify future instances of post 131.

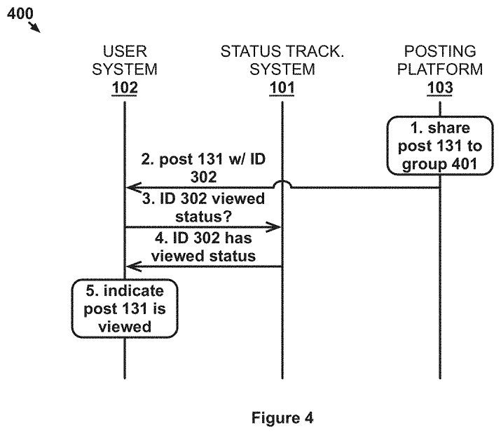

FIG. 4 illustrates operational scenario 400 for indicating that a post has been viewed across multiple instances of the post. In operational scenario 400, post 131 is shared by a user of group 301 to group 401, which is also maintained by posting platform 103, at step 1. For example, a user of both group 301 and group 401, such as user 142, may believe users of group 401 would appreciate the content of post 131. Posting platform 103, through user system 102, may provide an option that, when selected by a user of both groups, allows the user to share post 131 to group 401 (or some other group for which the user has access). A second instance of post 131 is, therefore, created in group 401 for the users thereof to view. The second instance of post 131 maintains unique identifier 302 since it is effectively a direct copy of post 131 from group 301. In some cases, posting platform 103 may include only one actual copy of post 131 and the separate instances of post 131 in group 301 and group 401 may be pointers to that one copy.

Since user 142 is a user of both group 301 and group 401, when user 142 operates user system 102 to open posts in group 401, posting platform 103 sends post 131 at step 2 to user system 102 along with unique identifier 302. As in operational scenario 300, posting platform 103 may not send the entirety of post 131 at this time depending on configuration. In fact, unique identifier 302 may be all that is sent so that user system 102 can first determine whether post 131 has been viewed prior to receiving post 131. After receiving unique identifier 302, user system 102 queries status tracking system 101 at step 3 to determine whether unique identifier 302 is associated with a viewed post status in status repository 121. Since unique identifier 302 was associated with the viewed-post status in operational scenario 300, status tracking system 101 notifies user system 102 at step 4 that unique identifier 302 is associated with the viewed-post status. Now that user system 102 is aware of post 131 having already been viewed, user system 102 indicates to user 142 that the instance of post 131 in group 401 has already been viewed. Upon being notified that post 131 has already been viewed, user 142 may choose not to open post 131 in group 401, may choose to scroll right by post 131 when scanning posts in group 401, or may take some other action.

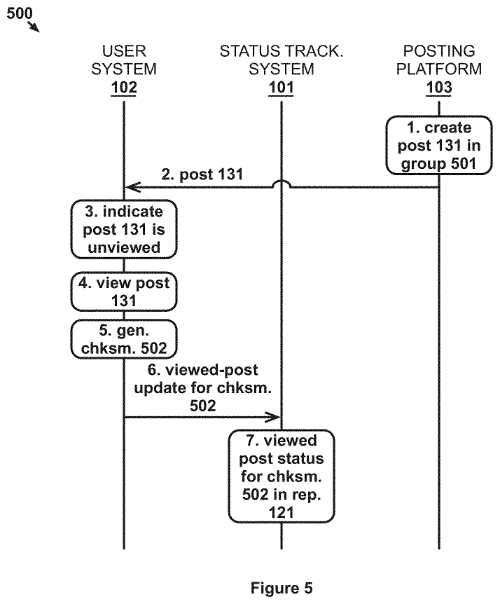

FIG. 5 illustrates operational scenario 500 for indicating that a post has been viewed across multiple instances of the post. Operational scenario 500 is an example where a checksum is used to identify post 131 rather than a unique identifier assigned by posting platform 103. While there may be situations where unique identifier 302 is shared across platforms (e.g., if posting platform 103 and posting platform 104 are owned by the same company), there are situations where unique identifier 302 would not be shared. Thus, a different way of identifying instances of post 131 may be used instead (e.g., the checksum described below) to enable tracking of viewed status across platforms.

In operational scenario 500, post 131 is created in group 501 at step 1 and sent to user system 102 at step 2. Post 131 may be created and sent to user system 102 in a similar manner, and a similar reason, to that described in operational scenario 300. Initially, user system 102 indicates to user 142 that post 131 is an unviewed post at step 3. Post 131 may be indicated as being unviewed based on status tracking system 101 indicating that no instance of post 131 has been viewed by user 142 yet in a manner similar to that described in operational scenario 600, based on user system 102 assuming that post 131 has not been viewed based on the creation time of post 131 (e.g., post 131 may have just been created and is, therefore, unlikely to have been shared/viewed elsewhere), or based on some other reasoning. At step 4, user 142 views post 131. Post 131 may be considered to be viewed for similar reasons as those described in operational scenario 300.

User system 102 generates checksum 502 from post 131 at step 5. Checksum 502 may be generated by feeding post 131 into a hash function, such as a function in Secure Hash Algorithm (SHA) 2 family of functions with SHA-256 shown to be secure and collision free. When fed with the exact same data (e.g., post 131), the hash function will always generate the same resulting checksum. Conversely, if the input data is changed ever slightly, then the resulting checksum will be different. Thus, checksum 502 can be used to uniquely identify post 131 without having to attach the identifier to post 131 like unique identifier 302 discussed above. Preferably, checksum 502 is generated from aspects of post 131 that would not change when shared or otherwise copied to other groups or channels. For example, each instance of post 131 may include a posting time for when post 131 originated in the group. Since that posting time will change between groups depending on when post 131 is posted thereto, the posting time would change the checksum even though the post is otherwise the same. As such, only the content of post 131 may be used to generate checksum 502 while all accompanying metadata, platform specific formatting, etc. may be left out of the checksum derivation. After generating checksum 502, user system 102 notifies status tracking system 101 at step 6 that post 131 has been viewed by sending a message instructing status tracking system 101 to update checksum 502 in status repository 121 with the viewed-post status. In response to that message, at step 7, status tracking system 101 stores checksum 502 in status repository 121 (if not stored already) and associates checksum 502 therein with the viewed-post status. Since checksum 502 identifies post 131, there is no need for status tracking system 101 to store post 131 itself in order to identify future instances of post 131.

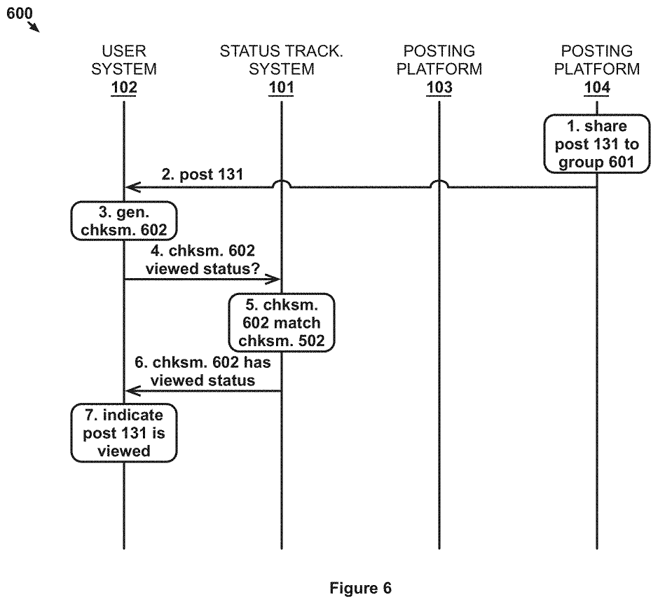

FIG. 6 illustrates operational scenario 600 for indicating that a post has been viewed across multiple instances of the post. In operational scenario 600, post 131 is shared by a user of group 501 to group 601, which is maintained by posting platform 104, at step 1. User system 102 may provide user 142 with an option to share post 131 to other groups, even those groups maintained by platforms other than posting platform 103. A second instance of post 131 is, therefore, created in group 601 for the users thereof to view.

Since user 142 is a user of both group 501 and group 601, when user 142 operates user system 102 to open posts in group 601, posting platform 104 sends post 131 at step 2 to user system 102. After receiving checksum 602, user system 102 generates checksum 602 from received instance of post 131 at step 3 in the same manner that checksum 502 was generated to ensure that checksum 602 and checksum 502 will match if post 131 received from posting platform 104 is indeed the same as post 131 received from posting platform 103. After deriving checksum 602, user system 102 queries status tracking system 101 at step 4 to determine whether checksum 602 matches a checksum stored in status repository 121 at step 5. In this example, checksum 602 matches checksum 502 and, since checksum 502 is associated with the viewed-post status, status tracking system 101 notifies user system 102 at step 6 that checksum 602 is associated with the viewed-post status. Now that user system 102 is aware of post 131 having already been viewed, user system 102 indicates to user 142 at step 7 that the instance of post 131 in group 401 has already been viewed. Upon being notified that post 131 has already been viewed, user 142 may choose not to open post 131 in group 401, may choose to scroll right by post 131 when scanning posts in group 401, or may take some other action.

While user system 102 calculates checksum 502 and checksum 602 in the above examples, status tracking system 101 may calculate the checksums in other examples. Status tracking system 101 may receive post 131 directly from posting platform 103 and posting platform 104 or may receive post 131 from user system 102 to perform the calculation.

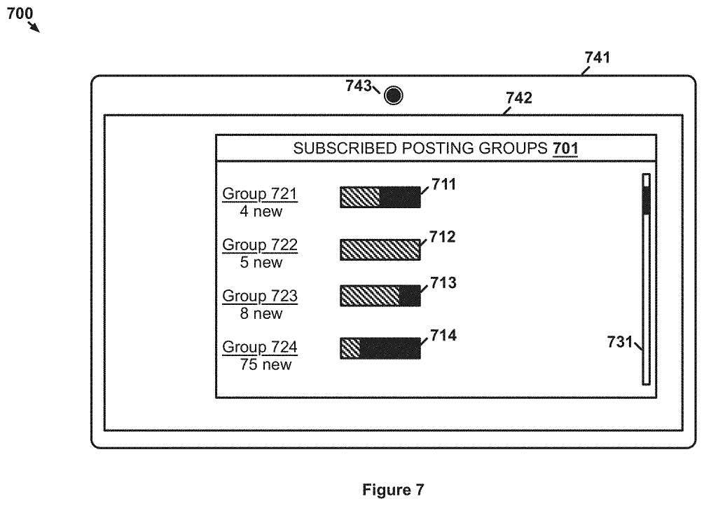

FIG. 7 illustrates implementation 700 for indicating that a post has been viewed across multiple instances of the post. Implementation 700 includes display system 741, which includes display screen 742 and camera 743. Display screen 742 may be a liquid crystal display (LCD), organic light emitting diode (OLED) display, cathode ray tube (CRT), or some other type of display in communication with processing circuitry user system 102. Camera 743 includes optics, such as a lens, and an image sensor, also in communication with processing circuitry of a user system, that captured photos and/or video, which may be included in posts to communication channels. Camera 743 may be omitted in some examples.

Display system 741 is a display system of user system 102 that is displaying subscribed posting groups window 701. Subscribed posting groups window 701 is a client application interface for user 142 to interact with posting platform 103. In this example, user 142 is able to access at least groups 721-724 but additional groups may be accessed using scroll bar 731. Posting platform 103 provides a number of new posts since user 142 last viewed the posts in each group. For example, group 721 includes four new messages while group 724 includes 75 new messages. Based on viewed-post status information determined by status tracking system 101 for the new posts in each group, post status bars 711-714 are also displayed in subscribed posting groups window 701 by user system 102. Each of post status bars 711-714 are filled with two different colors representing the proportion of the new posts therein that have already been viewed. In this case, the dark color represents posts that have already been viewed in other groups (i.e., posts that are new to the group but not to user 142) while the light color represents posts that have not yet been viewed by user 142. As such, post status bar 711 indicates that half of group 721's new posts have already been viewed, post status bar 712 indicates that none of group 722's new posts have already been viewed, post status bar 713 indicates that 25% of group 723's new posts have already been viewed, and post status bar 714 indicates that 75% of group 724's new posts have already been viewed. In some examples, user 142 may also be presented with actual numbers of already viewed and/or not viewed posts. The aforementioned numbers may be displayed by default in posting groups window 701 (i.e., without requiring any user action directing their display) or the user may direct user system 102 to display the numbers. In one example, hovering over one of post status bars 711-714 with a mouse cursor may trigger the display of the numbers (e.g., as a popup nearby the associated post status bar). In a more specific example, hovering over the darker portion may display the number of new posts that have already been viewed while hovering over the lighter portion may display the number of new posts that have not yet been viewed. Also, graphical elements other than bars may be used instead to represent the proportions of new posts that have already been viewed. For example, a circular graphic may be presented that is filled in a pie-chart manner proportionally to the number of new posts that have been viewed. In some examples, a color coding scheme may be used where different colors indicate proportions of the new posts in a group that have already been viewed.

By indicating to user 142 that supposedly new posts in a group have already been viewed, user 142 can better determine how much of their attention will be necessary to review the new posts. For example, while group 724 shows 75 new posts, user 142 knows that they do not need to review all 75 since most of the new posts have been viewed by user 142 elsewhere (e.g., in one of the other groups).

Since user 142 has yet to open any of groups 721-724, status tracking system 101 may analyze, in the background, the new posts in each group to determine which, if any, of the new posts in each group have already been read by user 142. In particular, status tracking system 101 may access the new posts without user 142 having to open any of groups 721-724 and may then determine which of the posts have the viewed-post status in status repository 121 using one of the methods described above. Status tracking system 101 may wait until user 142 opens subscribed posting groups window 701 to determine which new posts have already been viewed, may wait until user 142 logs into posting platform 103, may periodically identify viewed posts even when user 142 is not logged into or actively using posting platform 103, may identify whether a post is viewed each time a new post is posted, or may identify viewed posts on some other schedule.

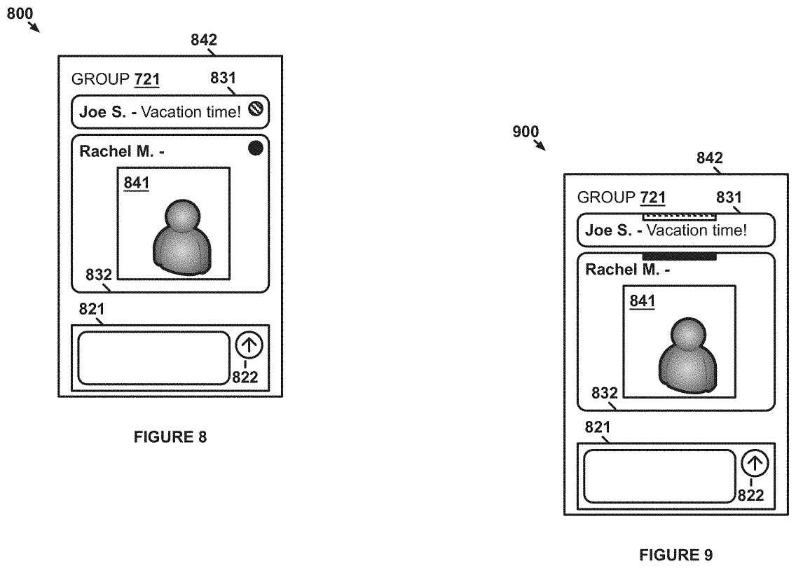

FIG. 8 illustrates implementation 800 for indicating that a post has been viewed across multiple instances of the post. Implementation 800 includes display screen 842. Display screen 842 may be a display screen similar to display screen 742, although display screen 842 is shaped differently. For example, display screen 842 may be a smartphone display while display screen 742 may be a laptop display. It should be understood that display screen 742 and display screen 842 may each be capable of displaying similar information, although, that information may be displayed differently to conform to physical differences between display sizes (e.g., display screen 842 may also display the post status bars displayed by display screen 742). In this example, display screen 742 is displaying two posts from within group 721, post 831 and post 832. User 142 may be able to view other posts within group 721 by scrolling up and/or down from posts 831 and 832. Display screen 842 further displays post entry box 821 into which user 142 may enter content for a new post before selecting submission button 822 to post the content to group 721.

In the upper corner of post 831 and post 832 there are circles representing Like in implementation 700, a dark color represents a post that has been viewed and a light color represents a post that has not been viewed. In this case, post 831 has not been viewed while post 832 has been viewed. User 142 may, therefore, pause when scrolling through posts in group 721 to read post 831 while scrolling past post 832 because user 142 has already viewed photo 841 from post 832 elsewhere (e.g., in another group). Once user 142 is considered to have viewed post 831, then the circle for post 831 may be changed to the dark color to represent that post 831 has been viewed. Status tracking system 101 may also update status repository 121 with an identifier for post 831 and associate the identifier with a viewed-post status.

FIG. 9 illustrates implementation 900 for indicating that a post has been viewed across multiple instances of the post. Implementation 900 is an example of display screen 842 where the indicators are rectangular shaped and positioned differently from those in implementation 800. Other shapes and manners of indicating that post 832 has been viewed already may also be used. For example, post 832 may be greyed out, collapsed, or hidden completely so as to not distract user 142 from posts that have not been viewed. In some cases, the indicators provided by status tracking system 101 may replace group 721's own read post indicators, which only track whether a post was viewed within group 721 itself, or may be presented in addition to group 721's own indicators.

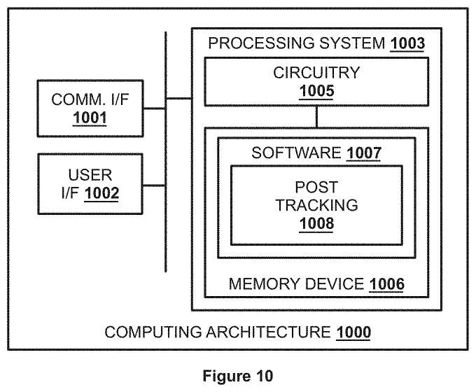

FIG. 10 illustrates computing architecture 1000 for indicating that a post has been viewed across multiple instances of the post. Computing architecture 1000 is an example computing architecture for status tracking system 101, although system 101 may use alternative configurations. A similar architecture may also be used for other systems described herein (e.g., user system 102 and systems of posting platforms 103 and 104), although alternative configurations may also be used. Computing architecture 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007.

Communication interface 1001 comprises components that communicate over communication links, such as network cards, ports, RF transceivers, processing circuitry and software, or some other communication devices. Communication interface 1001 may be configured to communicate over metallic, wireless, or optical links. Communication interface 1001 may be configured to use TDM, IP, Ethernet, optical networking, wireless protocols, communication signaling, or some other communication format—including combinations thereof.

User interface 1002 comprises components that interact with a user. User interface 1002 may include a keyboard, display screen, mouse, touch pad, or some other user input/output apparatus. User interface 1002 may be omitted in some examples.

Processing circuitry 1005 comprises microprocessor and other circuitry that retrieves and executes operating software 1007 from memory device 1006. Memory device 1006 comprises a computer readable storage medium, such as a disk drive, flash drive, data storage circuitry, or some other memory apparatus. In no examples would a storage medium of memory device 1006 be considered a propagated signal. Operating software 1007 comprises computer programs, firmware, or some other form of machine-readable processing instructions. Operating software 1007 includes post tracking module 1008. Operating software 1007 may further include an operating system, utilities, drivers, network interfaces, applications, or some other type of software. When executed by processing circuitry 1005, operating software 1007 directs processing system 1003 to operate computing architecture 1000 as described herein.

In particular, post tracking module 1008 directs processing system 1003 to, in response to determining that a user has viewed a first instance of a post to an electronic communication channel, associate the post with a viewed-post status in a post-tracking repository. Post tracking module 1008 further directs processing system 1003 to identify a second instance of the post and indicate to the user that the second instance has been viewed based on the post being associated with the viewed-post status.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
in response to being notified by a user system that a user has viewed a first instance of a post to a first electronic communication channel:
determining a unique identifier for the post, wherein the unique identifier is attached to the first instance in metadata for the first instance, and
associating the unique identifier with a viewed-post status in a post-tracking repository;
after receiving the notification, being queried by the user system to determine whether the unique identifier attached to a second instance of the post to a second electronic communication channel is associated with the viewed-post status; and
after being queried, indicating to the user that the second instance has been viewed in the second electronic communication channel based on the unique identifier being associated with the viewed-post status.

2. The method of claim 1, wherein indicating to the user that the second instance has been viewed comprises:
displaying the second instance with a visual indicator thereon that is representative of the post having already been viewed.

3. The method of claim 2, wherein the visual indicator comprises a first color that is different than a color that is representative of an unviewed post.

4. The method of claim 1, wherein indicating to the user that the second instance has been viewed comprises:
determining that a posting group includes new posts, including the second instance, since last opened by the user; and
displaying a group indicator for the posting group with a visual indicator that at least one of the new posts has already been viewed.

5. The method of claim 4, wherein the visual indicator indicates a proportion of the new posts that have already been viewed.

6. The method of claim 5, wherein the proportion is represented by an amount in which a shape of the visual indicator is filled with a first color.

7. The method of claim 1, wherein determining the unique identifier comprises:
receiving the unique identifier with the notification.

8. The method of claim 1, wherein a posting platform hosting the first electronic communication channel assigns the unique identifier to the post when the post is created.

9. The method of claim 1, wherein the first electronic communication channel is different from the second electronic communication channel.

10. The method of claim 1, comprising:
in response to determining that a threshold amount of time has elapsed since associating the unique identifier with the viewed-post status, disassociating the unique identifier from the viewed-post status.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
in response to being notified by a user system that a user has viewed a first instance of a post to a first electronic communication channel:
determine a unique identifier for the post, wherein the unique identifier is attached to the first instance in metadata for the first instance, and
associate the unique identifier with a viewed-post status in a post-tracking repository;
after receiving the notification, be queried by the user system to determine whether the unique identifier attached to a second instance of the post to a second electronic communication channel is associated with the viewed-post status; and
after being queried, indicate to the user that the second instance has been viewed in the second electronic communication channel based on the unique identifier being associated with the viewed-post status.

12. The apparatus of claim 11, wherein to indicate to the user that the second instance has been viewed, the program instructions direct the processing system to:
the second instance with a visual indicator thereon that is representative of the post having already been viewed.

13. The apparatus of claim 12, wherein the visual indicator comprises a first color that is different than a color that is representative of an unviewed post.

14. The apparatus of claim 11, wherein to indicate to the user that the second instance has been viewed, the program instructions direct the processing system to:
determine that a posting group includes new posts, including the second instance, since last opened by the user; and
display a group indicator for the posting group with a visual indicator that at least one of the new posts has already been viewed.

15. The apparatus of claim 14, wherein the visual indicator indicates a proportion of the new posts that have already been viewed.

16. The apparatus of claim 11, wherein to determine the unique identifier, the program instructions direct the processing system to:
receive the unique identifier with the notification.

17. The apparatus of claim 11, wherein a posting platform hosting the first electronic communication channel assigns the unique identifier to the post when the post is created.

18. The apparatus of claim 11, wherein the first electronic communication channel is different from the second electronic communication channel.

19. The apparatus of claim 11, wherein the program instructions direct the processing system to:
in response to determining that a threshold amount of time has elapsed since associating the unique identifier with the viewed-post status, disassociate the unique identifier from the viewed-post status.

20. One or more computer readable storage media having program instructions stored thereon that, when read and executed by a processing system, direct the processing system to:
in response to being notified by a user system that a user has viewed a first instance of a post to a first electronic communication channel:
determine a unique identifier for the post, wherein the unique identifier is attached to the first instance in metadata for the first instance, and
associate the unique identifier with a viewed-post status in a post-tracking repository;
after receiving the notification, be queried by the user system to determine whether the unique identifier attached to a second instance of the post to a second electronic communication channel is associated with the viewed-post status; and
after being queried, indicate to the user that the second instance has been viewed in the second electronic communication channel based on the unique identifier being associated with the viewed-post status.
